(19) United States
(12) Patent Application Publication
(10) Pub. No.: US 2007/0044890 A1
(43) Pub. Date: Mar. 1, 2007

(54) Machine for conditioning soybean straw

(75) Inventors: Jay Sherwood, Guthrie Center, IA (US); Bill Priestley, Guthrie Center, IA (US); Barry Monaghan, Guthrie Center, IA (US); Lynn Jorgensen, Panora, IA (US); Tom Neel, Panora, IA (US); Tim McDermott, Jamaica, IA (US)

Correspondence Address: MCKEE, VOORHEES & SEASE, P.L.C., 801 GRAND AVENUE, SUITE 3200, DES MOINES, IA, 50309-2721, US

(73) Assignee: PreMoMcNe, LLC, Panora, IA (US)

(21) Appl. No.: 11/213,206

(22) Filed: Aug. 26, 2005

(51) Int. Cl. B27N 3/00

(52) U.S. Cl. 156/62.2

(57) ABSTRACT

A machine is provided for removing pith from soybean straw, so that the straw can be used in the formation of fiber board. The machine includes a frame with inlet and outlet ends. A pair of compression rollers is mounted on the frame adjacent the inlet end and compresses the straw as the straw passes through the compression rollers. A pair of cutting rollers are provided downstream from the compression rollers and cut the straw along its length. A pair of crushing rollers is provided downstream from the cutting rollers and further crushes the straw so that the pith is easily removed therefrom. The cut and crushed straw is discharged from the machine and is ready for use in making fiber board. At least one roller in each pair of rollers is spring mounted to prevent binding of straw in the machine.

### BACKGROUND OF THE INVENTION

Soybean straw or stalks typically is a waste material following the bean harvest. Bean straw is normally tilled back into the ground, but the straw has very little nutrient benefits for the soil. Therefore, it is desirable to find a commercial use for soybean straw.

Straw from other agricultural grains has been used to make fiberboard by coating the straw with resin and compressing the composite material into boards. However, soybean straw differs from grain straw in that soybean straw includes pith within the straw, that is not present in other grains. Therefore, the machines and processes used to make fiberboard or strandboard from grain straw is not useful for soybean straw or other pith-containing plant stalks.

Accordingly, a primary objective of the present invention is the provision of the machine for conditioning soybean straw.

Another objective of the present invention is the provision of the machine for removing pith from soybean straw so that the straw can be used in fiber board.

A further objective of the present invention is the provision of a machine which aligns soybeans straw longitudinally for lengthwise cutting and crushing.

Still another objective of the present invention is the provision of a machine which automatically removes pith from soybean straw.

Another objective of the present invention is the provision of a process for removing pith from soybean straw.

These and other objectives have become apparent from the following description of the invention.

### BRIEF SUMMARY OF THE INVENTION

The machine for conditioning soybean straw according to the present invention includes a pair of compression rollers to compress soybean straw, a pair of cutting rollers to cut the straw lengthwise, and a pair of crushing rollers to crush the cut straw and thereby remove pith from the straw. The cutting rollers rotate at a higher RPM then the compression rollers, and the crushing rollers operate at a higher RPM then the cutting rollers, such that the straw is pulled through the machine. The two crushing rollers operate at different speeds, so as to create a sheering force on the straw passing there through. One roller in each pair of rollers is spring mounted for adjustable tension. A corrugated inlet chute aligns the straw longitudinally for introduction into the feed rollers.

### BRIEF DESCRIPTION OF THE DRAWINGS

FIG. 1 is a prospective view from one side of the machine.

FIG. 2 is a prospective view from the opposite side of the machine.

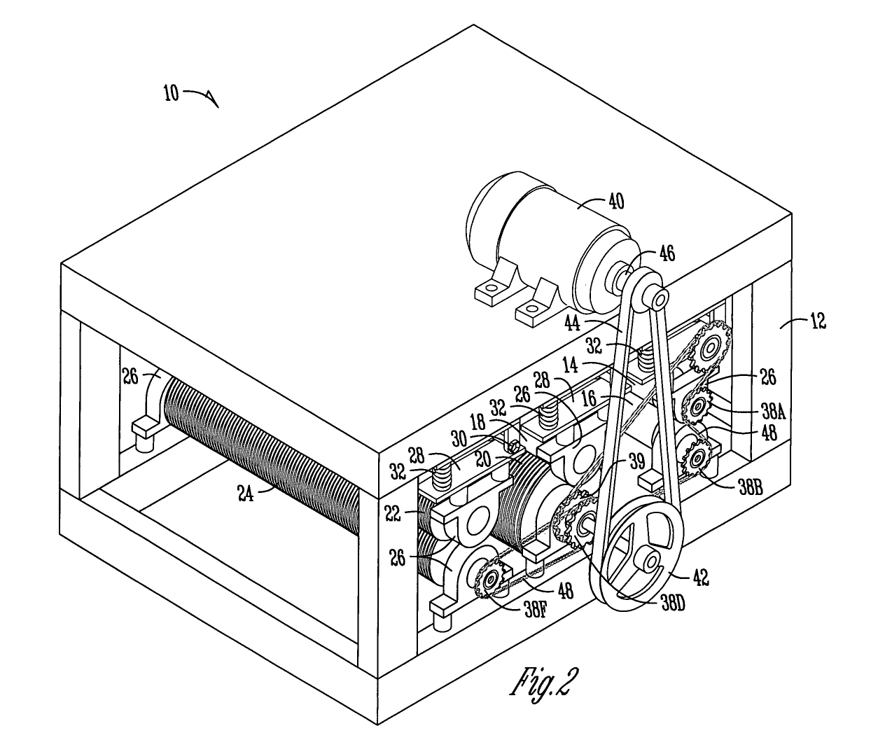

FIG. 3 is a view from the outlet end of the machine.

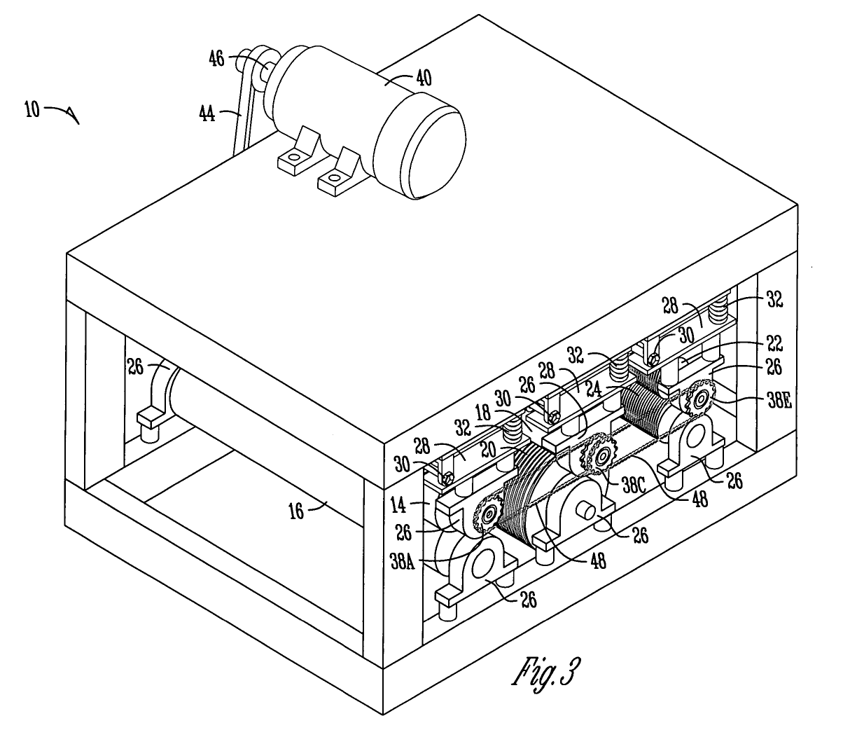

FIG. 4 is an enlarged view of the crusher rollers of the machine.

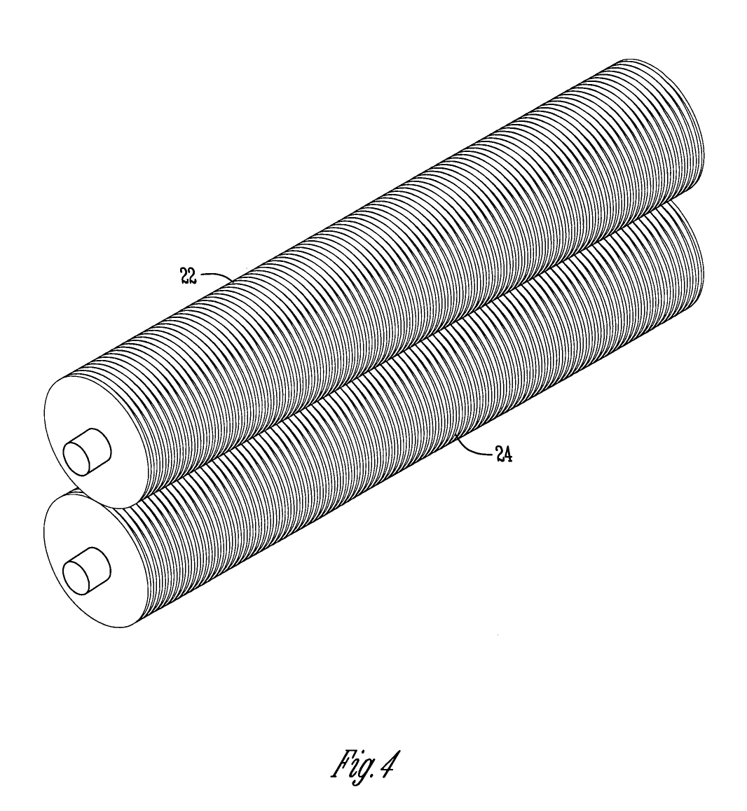

FIG. 5 is a schematic view showing the series of rollers in the machine.

### DETAILED DESCRIPTION OF THE PREFERRED EMBODIMENT

The soybean straw conditioning machine of the present invention is generally designated by the reference numeral 10 in the drawings. The machine includes a frame 12 having a series of rollers 14, 16, 18, 20, 22 and 24. Each end of the rollers 14-22 are mounted at opposite ends in bearings 26. Rollers 14, 16 compress the bean straw, rollers 18, 20 cut the bean straw, and rollers 22, 24 crush the bean straw, as described in more detail below.

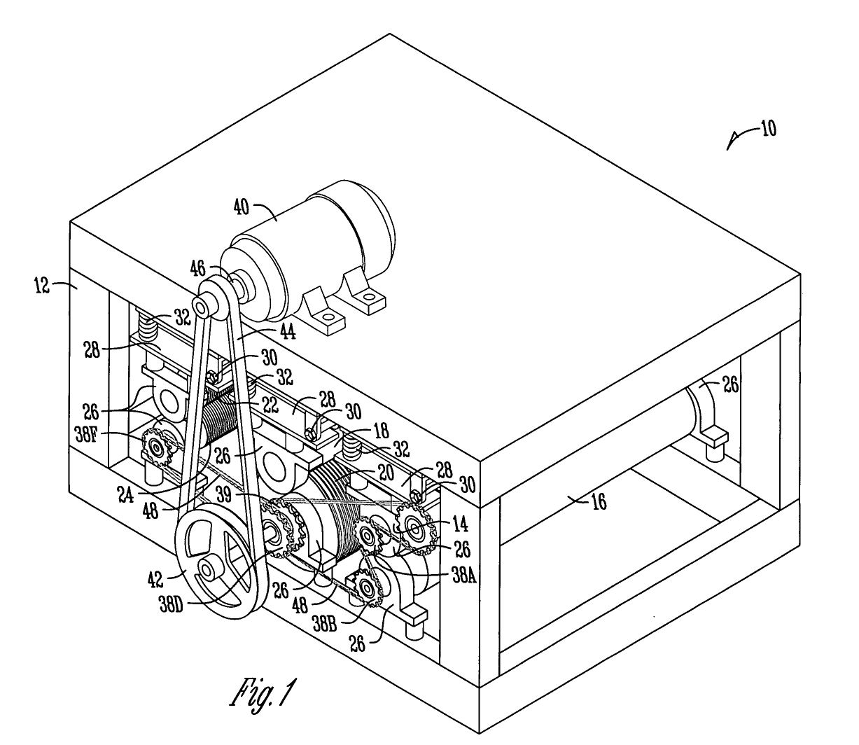

The top roller 14, 18 and 22 in each pair of rollers is spring mounted. More particularly, as seen in FIG. 1, bearings 26 for the upper rollers 14, 18 and 22 are mounted on a yoke assembly 28 having a pivot pin 30 at one end and a spring 32 at the other end. The spring 32 normally biases the top rollers 14, 18 and 22 into engagement with the lower rollers 16, 20 and 24, while allowing soybean straw to pass through each pair of rollers under pressure. An adjustment bolt 34 is provided on each yoke 28 to adjust the tension of the spring 32.

Each roller 14-24 includes a shaft 36 A-F with a sprocket 38 A-F mounted thereon. The rollers 14-24 are rotated by a drive train including a motor 40, an enlarged wheel 42, a drive belt 44 extending between the drive shaft 46 of the motor 40 and the wheel 42, and a plurality of drive chains 48 extending around the sprockets 38 A-F. The shaft 36 D includes a second sprocket 39. When the motor 40 is actuated, the belt 44 drives the wheel 42 so as to rotate the shaft 36 D in the sprockets 38 D, 39, which in turn drives the shafts 36 A, B, C, D and F via the chains 48.

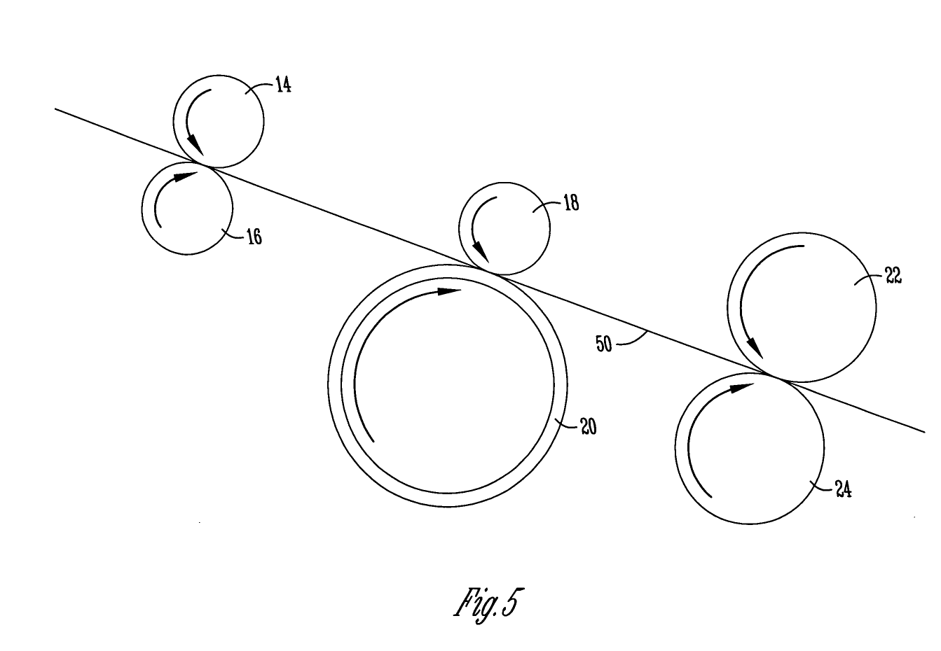

As seen in FIG. 5, the top rollers 14, 18, 22 turn one direction (shown in the drawings to be counterclockwise), while the lower rollers 16, 20, and 24 rotate in the opposite direction (shown to be clockwise in the drawings). Is also noted that the size of the sprockets 38 A-F vary, such that the speeds of the rollers vary. Preferably, the compression rollers 14, 16 rotate at approximately 250 RPM. The cutting rollers 18, 20 preferably rotate at approximately 350 RPM, thereby pulling the straw into the cutting rollers 18, 20 from the compression rollers 14, 16. The crushing rollers 24, 26 also operate at a higher RPM then the cutting rollers 18, 20, so as to pull straw into the crushing rollers 22, 24 from the cutting rollers 18, 20. Furthermore, the crushing rollers 22, 24 operate at different speeds from one another, so as to impart a sheering action to the straw passing there through. Preferably, the top crushing roller 22 operates as approximately 600 RPM, while the bottom crushing roller 24 operates at approximately 450 RPM.

Preferably, the compression rollers 14, 16 are made from rubber and function to initially crush the soybean straw passing there through. The upper cutting roller 18 is also preferably made of rubber; while the lower cutting roller 20 is made of metal preferably steel. The bottom cutting roller 20 also includes teeth for cutting the straw lengthwise, as the straw passes longitudinally between the cutting rollers 20, 22. In a preferred embodiment, the bottom cutting roller 20 is formed from a plurality of saw blades with spacer discs between adjacent blades. The saw blades are spaced approximately one-eighth inch apart and preferably do not have an increased width at the tips (commonly known as a “set” normally found on saw blades to prevent binding). The upper cutting roller 18 preferably has grooves corresponding to the spaced apart teeth on the lower cutting roller 20, such that soybean straw cannot pass between the cutting rollers 18, 20 without being cut. The downstream crushing rollers 22, 24 are preferably made of metal. Also, the rollers 22, 24 preferably have grooves formed around the perimeter to facilitate and enhance the crushing action of the rollers 22, 24.

As seen in FIG. 5, the rollers 14-24 are arranged on a downward sloping incline. Nip points of the rollers 14-20 define an inclined plane 50, which preferably is at approximately a 20 degree slope.

An inlet chute 52 is provided on the upstream end of the frame 12. The inlet chute 52 may take various forms, and should function to direct the soybean straw longitudinally or lengthwise into the feed rollers 14, 16. For example, the inlet chute may be corrugate metal with the corrugations extending perpendicular to the axis of the rollers 14, 16.

A support tray 54 extends between the pairs of rollers 14, 16, and 18, 20. A second support tray 56 extends between the pairs of rollers 18, 20 and 22, 24. The trays 54, 56 support the straw as it moves through the machine 10. An outlet chute or bin (not shown) may be provided on the downstream end of the frame 12 to receive the cut and crushed straw from the last set of rollers 22, 24. The tray 54 preferably includes fingers extending between the cutting blades of roller 20, adjacent the spacer discs to further support the straw as it moves into contact with the cutting rollers 18, 20.

In operation, the soybean straw is introduced into the inlet chute 52 for longitudinal feeding into the compression rollers 14, 16, which compress the straw. The straw then moves along the tray 54 into the cutting rollers 18, 20, which cut the straw longitudinally along its length. The straw is then carried by the tray 56 into the crushing rollers 22, 24, which further crushes the cut straw and pulverizes the pith which is then easily separable from the cut and crushed straw. The processed or conditioned straw with the pith removed therefrom is then ready to be used for the creation of fiberboard, including the coating with resin on both the inside and outside surfaces of the conditioned straw. A preferred method of manufacturing fiberboard from the de-pithed soybean straw is described in Applicant's co-pending application, Ser. No. ______ entitled Agricultural Stalk Strandboard.

It is understood that the machine 10 of the present invention can be used for other types of non-wood plant stalks that have pith to be removed. Such stalks include cotton and bassage, which can be de-pithed with the machine 10 for use in creating fiberboard or strandboard.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A machine for conditioning straw comprising:
a pair of compression rollers to compress the straw;
a pair of cutting rollers downstream from the compression rollers to cut the straw along its length;
a pair of crushing rollers downstream from the cutting rollers to crush the straw so as to remove pith from the straw.

2. The machine of claim 1 wherein the crushing rollers rotate at different speeds from one another.

3. The machine of claim 1 wherein the crusing rollers have grooves to facilitate pith removal.

4. The machine of claim 1 wherein at least one of the cutting rollers includes teeth.

5. The machine of claim 1 further comprising support trays extending between each pair of rollers.

6. The machine of claim 1 further comprising an inlet chute to feed straw into the feed rollers.

7. The machine of claim 1 wherein the pairs of rollers are inclined downwardly from an upstream end to a downstream end of the machine.

8. The machine of claim 1 wherein each pair of rollers has a nip point, with the nip points of the rollers defining an inclined plane.

9. The machine of claim 1 wherein the compression rollers have a rubber surface.

10. The machine of claim 1 wherein one of the cutting rollers has space apart teeth and the other cutting roller has spaced apart grooves to receive the teeth.

11. The machine of claim 10 wherein another of the cutting rollers has a rubber surface.

12. The machine of claim 1 further comprising a drive train for driving ther pairs of rollers.

13. The machine of claim 1 wherein one of each pair of rollers is spring mounted.

14. A machine for removing pith from soybean straw, comprising:
a frame having opposite inlet and outlet ends;
an inlet chute on the inlet end of the frame;
a pair of compression rollers mounted to the frame adjacent the inlet end of the frame;
a pair of crushing rollers mounted to the frame adjacent the outlet end of the frame:
a pair of cutting rollers mounted to the frame between the compression and crushing rollers;
the compression rollers feeding the straw longitudinally to the cutting rollers so as to cut the straw along its length, and then the crushing rollers crushing the straw to remove the pith from the straw and discharge the straw from the outlet end.

15. The machine of claim 14 wherein one of each pair of rollers is spring mounted.

16. The machine of claim 14 wherein the crushing rollers rotate at different speeds from one another.

17. The machine of claim 14 wherein the crushing rollers have grooves to facilitate pith removal.

18. The machine of claim 14 wherein each pair of rollers defines a nip point, with the nip points defining an inclined plane between the inlet and outlet ends of the frame.

19. A process for conditioning pith-containing plant stalks, comprising:
compressing the stalks;
cutting the stalks along its length; and
crushing the stalks so as to remove pith from the stalks.

20. The process of claim 19 further comprising passing the stalks through a series of rollers for compression, cutting and crushing.
